(19) United States
(12) Patent Application Publication
(10) Pub. No.: US 2007/0160089 A1
(43) Pub. Date: Jul. 12, 2007

(54) Synchronization system using at least one external office line signal and synchronization control method thereof

(76) Inventor: Young-Bum Suh, Suwon-si (KR)

Correspondence Address: Robert E. Bushnell;Suite 300, 1522 K Street, N.W., Washington, DC, 20005, US

(21) Appl. No.: 11/606,968

(22) Filed: Dec. 1, 2006

(30) Foreign Application Priority Data
Jan. 11, 2006 (KR) 10-2006-0003282

(51) Int. Cl. H04J 3/06; H04J 3/12

(52) U.S. Cl. 370/509; 370/522

(57) ABSTRACT

A synchronization system using at least one external office line signal, and a synchronization control method thereof. The synchronization system includes a plurality of framers receiving digital office line signals having a square wave form from a Public Switched Telephone Network (PSTN) through respective line interfaces, converting the digital office line signals into reference clock signals, and a synchronization frequency selector controlling a framer that first generates an interrupt, among the plurality of framers, to provide the corresponding reference clock signal. The synchronization system using at least one external office line facilitates line extension of a digital trunk of a keyphone switching apparatus, stably performs system synchronization by using the reference clock signal as an external synchronization clock to enhances system quality.

### CLAIM OF PRIORITY

This application makes reference to, incorporates the same herein, and claims all benefits accruing under 35 U.S.C.§119 from an application for SYNCHRONIZATION SYSTEM AND CONTROL METHOD FOR USING AT LEAST ONE OR MORE EXTERNAL OFFICE LINE SIGNAL earlier filed in the Korean Intellectual Property Office on 11 Jan. 2006 and there duly. assigned Serial No. 10-2006-0003282.

### BACKGROUND OF THE INVENTION

1. Field of the Invention

The present invention relates to a synchronization system using at least one external office line signal and a synchronization control method thereof.

2. Description of the Related Art

In a conventional synchronization method of a keyphone switching apparatus, a digital office line signal in the form of a square wave provided from an external office line switching office is received through a line interface, and then a reference clock signal (8 KHz) is extracted from the digital office line signal received through a framer.

Then, the reference clock signal (8 KHz) extracted through the framer is transmitted through a line controller to a main controller equipped with a Phase Locked Loop (PLL).

Then, the main controller equipped with the PLL divides the reference clock signal received through the line controller, generates synchronization signals required by respective components and provides the generated synchronization signals to the respective components through the line controller.

Meanwhile, when a plurality of digital trunks are used in the conventional synchronization method of the keyphone switching apparatus, priorities of the respective digital trunks are set, and when an error or a problem occurs in a digital trunk which provides a basic clock signal, the basic clock signal is sequentially provided beginning with a card having the highest priority.

The conventional synchronization method of the keyphone switching apparatus has problems which impose structural limitations, such as system material cost increase, line extension, connection method, and so on.

### SUMMARY OF THE INVENTION

It is an objective of the present invention to provide a synchronization system using at least one external office line signal capable of selecting a synchronization signal according to a synchronization priority in a system providing two or more links in a card, and a synchronization control method thereof.

In accordance with an aspect of the present invention, there is provided a synchronization system using at least one external office line signal. The synchronization system comprises: a plurality of framers receiving digital office line signals having a square wave form from a Public Switched Telephone Network (PSTN) through line interfaces, converting the digital office line signals into reference clock signals, and simultaneously setting interrupts to “high”; and a synchronization frequency selector for controlling a framer that first generates an interrupt among the plurality of framers to provide the corresponding reference clock signal.

Here, the synchronization frequency selector may comprise a a control processor for providing a “high” control signal so that the framer first generating the interrupt provides the reference clock signal, and providing a “low” control signal so that the remaining framers cannot provide the reference clock signal; and a MUX receiving each of the reference clock signals from the framers and then selectively transmitting one of the reference clock signals in response to the “high” and “low” control signals of the control processor. Also, the system may further comprise a plurality of latches delaying the received “high” and “low” control signals from the control processor, and providing the delayed results to the MUX.

Meanwhile, the control processor may change the control signals provided to the latches only when a change occurs in the interrupts of the framers providing the reference clock signal.

In accordance with another aspect of the present invention, there is provided a synchronization control method using at least one external office line signal. The synchronization control method comprises the steps of: determining whether interrupts are generated from a plurality of framers receiving the digital office line signals; when the interrupts are generated from the plurality of framers, detecting a framer that first generates an interrupt; and providing a “high” control signal so that the framer that first generates the interrupt provides the reference clock signal, and simultaneously providing a “low” control signal so that the remaining framers cannot provide the reference clock signal.

In accordance with yet another aspect of the present invention, there is provided a synchronization control method using at least one external office line signal. The synchronization control method comprises the steps of: determining whether a change occurs in an interrupt of a framer providing a reference clock signal; and when the change occurs in the interrupt of the framer providing the reference clock signal, changing control signals provided to a plurality of framers.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a functional block diagram of a synchronization system using at least one external office line signal according to an exemplary embodiment of the present invention;

FIG. 2 is a functional block diagram of a digital trunk in the synchronization system using at least one external office line signal illustrated in FIG. 1.

FIG. 3 is a flowchart illustrating a synchronization control method using at least one external office line signal according to an exemplary embodiment of the present invention; and

FIG. 4 is a flowchart illustrating the synchronization control method using at least one external office line signal according to FIG. 3.

### DETAILED DESCRIPTION OF EXEMPLARY EMBODIMENTS

Hereinafter, exemplary embodiments of the present invention will be described in detail with reference to the accompanying drawings. In the following description, a detailed description of known functions and configurations incorporated herein has been omitted for conciseness.

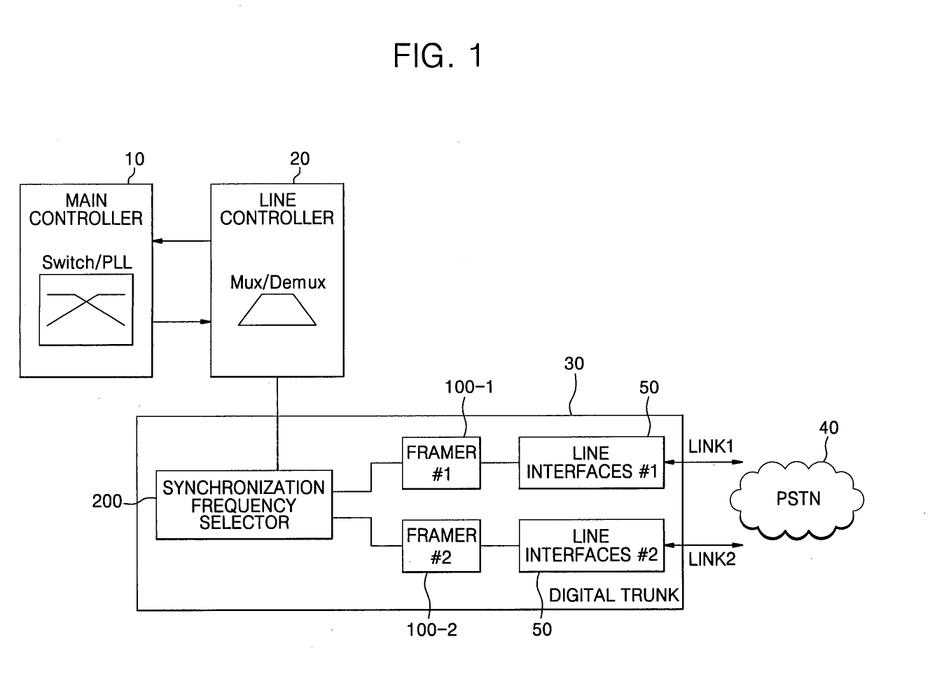

FIG. 1 is a functional diagram of a synchronization system using at least one external office line signal according to an exemplary embodiment of the present invention. The synchronization system using at least one external office line signal according to the present invention comprises a digital trunk 30 having first and second line interfaces 50 connected between a Public Switched Telephone Network (PSTN) 40 and first and second framers 100-1 and 100-2, and a synchronization frequency selector 200. Also illustrated are a line controller 20, and a main controller 10.

When digital office line signals having a square wave form are received from PSTN 40 through respective line interfaces 50, the first and second framers 100-1 and 100-2 convert the digital office line signals into reference clock signals, provide the reference clock signals to the line controller 20 and simultaneously set interrupts to “high”.

The synchronization frequency selector 200 selects a reference clock signal for output from the one of the first and second framers 100-1 and 100-2 that first generates an interrupt. Here, the synchronization frequency selector 200 operates as shown in Table 1.

TABLE 1

| Interrupt | | | |
|---|---|---|---|
| of First | Interrupt of Second | Output of First | Output of Second |
| Framer | Framer | Framer | Framer |
| 0 | 0 | 0 | 0 |
| 0 | 1 | 0 | 1 |
| 1 | 0 | 1 | 0 |
| 1 | 1 | Sustain | Sustain |

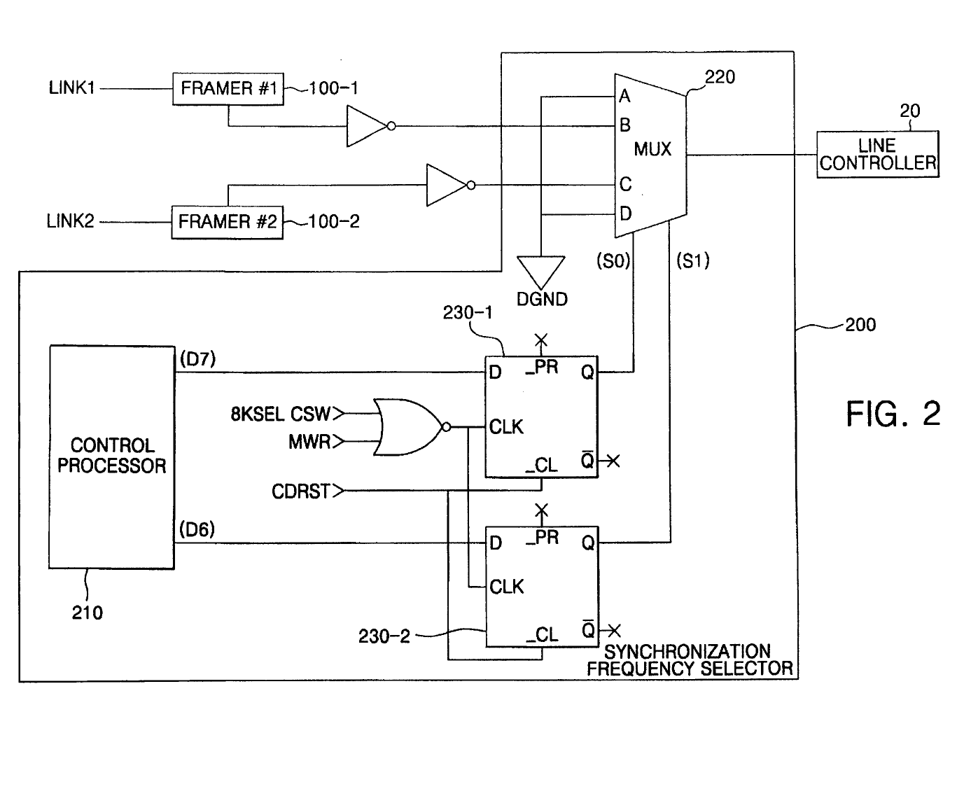

As shown in FIG. 2, the synchronization frequency selector 200 comprises a control processor 210, a MUX (multiplexer or swithch) 220, and latches 230-1 and 230-2.

The control processor 210 provides logic control signals to MUX 220 via latches 230-1 and 230-2, wherein a “high” control signal is provided to a framer port of the MUX 220 so that the first or second framer 100-1 or 100-2 that first generates an interrupt can provide the reference clock signal to line controller 20, and a “low” control signal is provided to another framer port of the MUX 220 so the remaining framer 100-1 or 100-2 that generates a later interrupt cannot provide the reference clock signal to line controller 20.

The control processor 210 changes the logic state of the control signals provided to the MUX 220 through the latches 230-1 and 230-2 only when the interrupt(s) of the first or second is framers 100-1 and 100-2 providing the reference clock signals changes.

The MUX 220 receives the reference clock signals from the first and second framers 100-1 and 100-2 and then selectively transmits one of the reference clock signals in response to the “high” and “low” control signals of the control processor 210.

The latches 230-1 and 230-2 delay the “high” and “low” control signals received from the control processor 210 and provide the delayed “high” and “low” control signals to the MUX 220.

A detailed description of known functions and configurations incorporated herein will be omitted. A synchronization control method according to the present invention will now be described with reference to FIGS. 1 and 2.

First, the synchronization apparatus according to the present invention is connected to the PSTN 40 through at least one link.

A digital trunk 30 connected to the PSTN 40 extracts a reference clock signal (8 kHz) from the digital office line signals received through the link interfaces 50, and transmits the reference clock signal to the main controller 10 through the line controller 20. The main controller 10 generates a synchronization clock signal required by the system on the basis of the received reference clock signal and provides the synchronization clock signal to respective components through the line controller 20.

The digital trunk 30, which receives at least one digital office line signal from the PSTN 40, selects one of a plurality of reference clock signals and provides the selected reference clock signal to the main controller 10.

The first framer 100-1 and the second framer 100-2 generate interrupts and reference clock signals, respectively, when the digital office line signals are received through the respective line interfaces 50.

The control processor 210 of the synchronization frequency selector 200 monitors the first framer 100-1 and the second framer 100-2 and detects one framer, i.e., the first framer 100-1 or the second framer 100-2 that first generates an interrupt.

When the first framer 100-1 first generates the interrupt, the control processor 210 provides a “high” control signal to a first framer port of the MUX 220 so that only the first framer 100-1 which first generates the interrupt can provide the reference clock signal to the main controller 10 via line controller 20, and provides a “low” control signal to a second framer port of the MUX 220. Here, the first framer 100-1 and the second framer 100-2 perform the same function and the above-described operation is applied only when a reference clock signal for synchronization is provided.

The main controller 10 receives the reference clock signal through the line controller 20, generates a synchronization clock signal required by the system through a Phase Locked Loop (PLL) of the main controller 10 using the reference clock signal, and provides the generated synchronization clock to respective components.

Although not illustrated in the drawings, the generated synchronization clock signal is provided to external apparatuses, such as digital subscribers, analog subscriber VoIP Gateways, etc., connected to the line controller 20.

Then, the control processor 210 of the digital trunk 30 determines whether a change occurs in the interrupt of the first framer 100-1 providing the reference clock signal to the main controller 10.

If a change occurs in the interrupt of the first framer 100-1, for example, if the interrupt changes from “high” to “low”, the control processor 210 of the digital trunk 30 selects the second framer 100-2 if it has generated a “high” interrupt, thereby stably supplying the reference clock signal.

If neither framer generates a “high” interrupt, then the controls signals generated by control processor 210 to the MUX 220 each have a “low” logic state, as shown in Table 1 above.

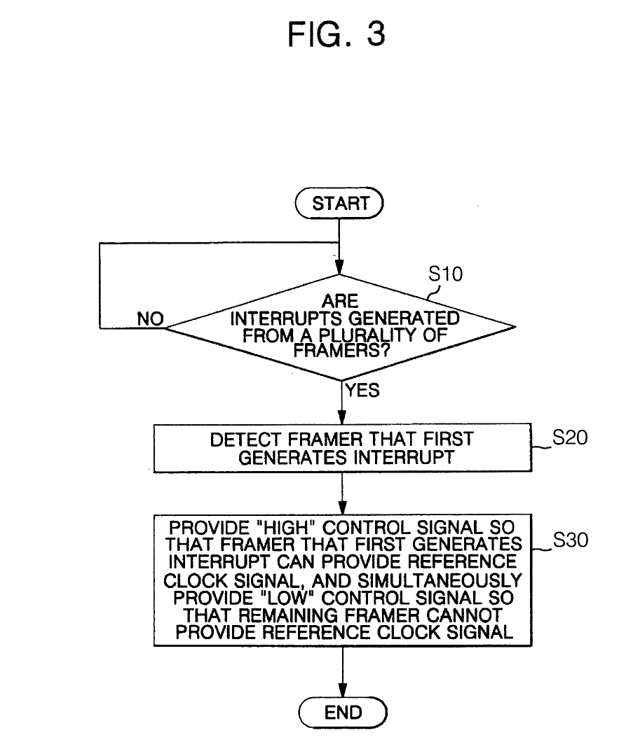

Below, a synchronization control method using at least one external office line signal, according to an exemplary embodiment of the present invention, will be described with reference to FIG. 3.

First, in step S10, the digital trunk 30 determines whether an interrupt is generated from at least one of the first and second framers 100-1 and 100-2 which receive digital office line signals from the PSTN 40 through at least one link.

If an interrupt is generated from at least one of the first and second framers 100-1 and 100-2 in step S10, the digital trunk 30 detects the first or second framer 100-1 or 100-2 that first generates the interrupt in step S20.

Then, in step S30, if the first framer 100-1 first generates the interrupt, the digital trunk 30 provides a “high” control signal to the first framer port of the MUX 220 so that the first framer 100-1 can provide the reference clock signal, and simultaneously provides a “low” control signal to the second framer port of the MUX 220 so that the second framer 100-2 cannot provide the reference clock signal.

In this manner, when the reference clock signal is provided to the main controller 10 through the line controller 20 from the framer that first generates an interrupt, the main controller 10 receives the reference clock signal through the line controller 20, generates a synchronization clock signal required by the system through the PLL of the main controller 10 using the reference clock signal, and provides the generated synchronization clock signal to the respective components.

Although not illustrated in the drawings, the synchronization clock signal is provided to external apparatuses, such as digital subscribers, analog subscriber VoIP Gateways, etc., connected to the line controller 20.

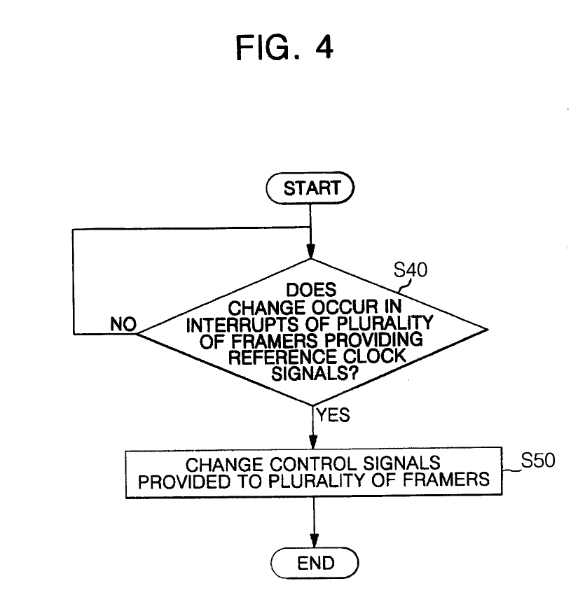

A case when an error or a problem occurs in the first framer 100-1 that receives a digital office line signal from the PSTN 40 through at least one link and provides a reference clock signal will now be described with reference to FIG. 4.

First, in step S40, the control processor 210 determines whether a change occurs in the interrupts of the first framer 100-1 and second framer 100-2 in step S40.

If a change occurs in the interrupts, the control processor 210 changes logic state of the control signals provided to the MUX 220, in step S50, according to Table 1 above.

As described above, in a synchronization system using at least one external office line signal and a synchronization control method thereof according to the present invention, it is possible to facilitate line extension of a digital trunk of a keyphone switching apparatus and stably perform system synchronization by using an external synchronization clock signal, thereby enhancing system quality.

While the present invention has been described with reference to exemplary embodiments thereof, it will be understood by those skilled in the art that various changes in from and detail may be made therein without departing from the scope of the present invention as defined by the following claims.

What is claimed is:

1. A synchronization system using at least one external office line signal, comprising:
a plurality of framers receiving digital office line signals having a square wave form from a Public Switched Telephone Network (PSTN) through line interfaces, converting the digital office line signals into reference clock signals, and simultaneously setting interrupts to “high”; and
a synchronization frequency selector for controlling the one of said framer that first generates an interrupt among the plurality of framers to provide the corresponding reference clock signal.

2. The synchronization system as set forth in claim 1, wherein the synchronization frequency selector comprises:
a multiplexer receiving each of the reference clock signals from the framers and then selectively transmitting one of the reference clock signals in response to a plurality of logic control signals; and
a control processor for providing said plurality of logic control signals as “high” and “low” control signals, said “high” control signal enabling said multiplexer to pass said reference clock signal generated by said framer first generating the interrupt, and said “low” control signal preventing said multiplexer from passing the reference clock signals generated by the remaining framers.

3. The synchronization system as set forth in claim 2, further comprising a plurality of latches connected between the control processor and the multiplexer, said latches delaying the “high” and “low” control signals received from the control processor and providing the delayed “high” and “low” control signals to the multiplexer.

4. The synchronization system as set forth in claim 2, wherein the control processor changes the logic state of the control signals provided to the multiplexer only when a change occurs in the interrupts of the framers providing the reference clock signals.

5. The synchronization system as set forth in claim 3, wherein the control processor changes the logic state of the control signals provided to the latches only when a change occurs in the interrupts of the framers providing the reference clock signals.

6. A synchronization system control method using at least one external office signal, comprising steps of:
determining whether interrupts are generated from a plurality of framers receiving the digital office line signals;
when the interrupts are generated from the plurality of framers, detecting a framer that first generates an interrupt; and
providing a first logic control signal having a “high” logic value so that the framer that first generates the interrupt provides the reference clock signal, and simultaneously providing a second logic control signal having a “low” logic value so that the remaining framer cannot provide the reference clock signal.

7. The synchronization system control method as set forth in claim 6, further comprising steps of:
providing said first control signal to a first port of a multiplexer for enabling said multipler to pass said reference clock signal generated by the framer that first generates the interrupt; and
providing said second control signal to a second port of said multiplexer for preventing said multipler from passing said reference clock signal generated by the remaining framer.

8. The synchronization system control method as set forth in claim 7, wherein said interrupts have a“high” logic value.

9. The synchronization system control method as set forth in claim 8, further comprising steps of:
detecting the logic values of said interrupts;
changing the first logic control signal to a “low” logic value when the interrupt of the framer that first generated the interrupt changes from a “high” logic value top a “low” logic valueprovides the reference clock signal to prevent said multipler from passing said reference clock signal of the framer that first generated the interrupt; and
changing the second logic control signal to a “high” logic value when the remaining framer has an interrupt having a “high” logic value to enable said multipler to pass said reference clock signal generated by said remaining framer.

10. A synchronization system control method using at least one external office line signal, comprising the steps of:
determining whether a change occurs in an interrupt of a framer providing a reference clock signal; and
when the change occurs in the interrupt of the framer providing the reference clock signal, changing control signals provided to a plurality of framers.
